(19) United States
(12) Patent Application Publication
(10) Pub. No.: US 2019/0160380 A1
(43) Pub. Date: May 30, 2019

(54) PLATFORM SYSTEM FOR PRODUCT MARKETING SERVICES

(71) Applicant: Mihee BAE, Busan (KR)

(72) Inventor: Mihee BAE, Busan (KR)

(21) Appl. No.: 15/821,999

(22) Filed: Nov. 24, 2017

(51) Int. Cl. A63F 13/61; A63F 13/79

(52) U.S. Cl. CPC A63F 13/61; G06Q 30/0261; A63F 13/79

(57) ABSTRACT

The present invention relates to a platform system for product marketing services. The system includes: a mileage providing unit that pays mileage for certain online activities; a marketing game preparing unit that receives an image file containing specifications and promotional information of a product to be marketed from a vendor's terminal; a marketing game generating unit that is linked to the aforesaid marketing game preparing unit, generates a game program to which a timer module and a stopwatch module are applied, and starts the program at a predetermined time; and a marketing game control unit that subtracts a predetermined mileage from at least one member ID connected to the game program and selects a prize winner with the member ID that closes closest to the specified second by using the stopwatch module at the time set by the timer module.

### BACKGROUND OF THE INVENTION

### Field of the Invention

The present invention relates to a platform system for product marketing services, more specifically to a platform system for product marketing services that can promote products at a minimum cost and attract consumers' attention.

### Description of Related Art

In general, for commerce, a distribution channel between ‘company-wholesaler-retailer-consumer’ should be established, a large number of salespeople are needed to grasp customer demand, and a sales space is needed to display merchandise.

Such a transaction method, however, has a problem that a transaction area is limited to a certain area, business hours are limited, and a sales space is required.

Accordingly, in recent years, shopping malls using the Internet has been established, solving the above-mentioned problems to some extent. That is, there is an advantage that the distribution channel from company to consumer is shortened and the sales space is not necessary because the sales base is transferred to the virtual space without being restricted by the transaction area and the transaction time.

Electronic Commerce (EC) refers to buying and selling products using the Internet or PC communication. In a broad sense, it includes all the purchases of goods and services made through computer networks, and the activities of ordering advertisements.

The biggest advantage of such electronic commerce is that there is no restriction of time and space, so people can save themselves the trouble of going to store directly, and the transaction price is mainly paid by credit card. In addition, it has no costs for distribution or building rent and is likened to a high-tech rich fishing ground in that all Internet subscribers all over the world are potential customers. It is also included in the commerce at the light speed (CALS).

Therefore, for such electronic commerce, there exist a large number of shopping malls through internet or PC communication network.

On the other hand, as a method of notifying the general public of a product or a specific company, many companies have used magazines, newspapers, broadcasts, distributed handbills to individuals, or attached handbills to the walls.

However, such a method is a method of indiscriminately and randomly advertising to an unspecified number of people, causing a lot of costs but not providing advertising effect as expected since it advertises a product or a company itself to people who do not need it.

Therefore, the popularization of the Internet has a great impact on all industrial sectors as well as the rapid development of information and communication, transforming the whole global village into a huge community of information.

Generally, a web browser, which is widely used in the Internet field, mainly in the World Wide Web (WWW), is provided as a tool that is easy to use and easy to access the Internet. Users can easily exchange or retrieve information between remote sites by using such a web browser.

Especially, as Internet users increases explosively, researches on a technique of providing advertisements to users are underway.

Thus, unlike advertising using a conventional advertising medium such as a radio, television, or cable television, the advertisement through the Internet has the advantage of being able to perform one-to-one advertising according to the consumer's tendency, securing the distribution network integrated with advertisement itself to provide information to customers, and measuring the advertising effect.

The techniques of Internet advertising include banner advertisement, pop-up advertisement, flash advertisement, UCC (User Created Contents) advertisement, and keyword search advertisement.

Advertising via banner/pop-up/flash/UCC is a technique of attaching an advertisement screen to a specific location of websites and linking it to the website of the advertisement provider. These ads consist of a variety of content, from plain text to video, and end with a single exposure (primary exposure).

Keyword search ad is an advertising technique in which an ad is exposed by a search result of a keyword inputted by a user. This is an advertisement technique that induces more users to access the advertisement provider site by exposing the advertisement matching the keyword received from the user.

These ads using banners, pop-ups, flash, UCC, and keyword search are now available through various websites, but they have the following problems.

Banner ads, pop-up ads, flash ads, and UCC ads are mostly displayed randomly to Internet users, and at the same time there is no benefit at all. Therefore, it is very difficult to attract user's attention, and it is almost impossible to verify how much the actual advertisement effect is. In addition, since it is impossible to confirm the sex or age group of the users who confirms the advertisement, it is impossible to statistically determine the tendency of the users such as which class is more interested in the individual advertisement. Moreover, since users are exposed to those ads only once or to only a single ad, their effect is significantly low.

Keyword search ads provide ads only when they match a keyword. Since the provided ad is terminated by one exposure, the advertisement effect is remarkably low and it is very difficult to verify the degree of the actual advertisement effect.

Therefore, from the standpoint of the advertiser, it is required to have an advertisement method that can easily grasp statistically the age and sex of the user who confirms his/her advertisement while motivating internet users to more positively identify online advertisements on websites.

On the other hand, various Internet-based online auctions are now operated on various websites, most of which are done in some modified ways from the usual offline auctions. In other words, the current online auctions, including reverse auctions, require the user to present the appropriate bid price for the auction through a web page, so a user participating in the auction has to decide the bidding price carefully in order to win the auction and, at the same time, offer a relatively expensive bid price for winning.

For this reason, conventional online auctions in which only the user who want to win the goods participate are not an auction method in which an unspecified number of users can participate without burden of cost. Accordingly, conventional online auctions are not an auction method that can be utilized in terms of advertising.

However, considering the fact that Internet-based online shopping is taking up a larger portion of the total commerce, it is required to have a more advanced type of advertisement method that enables the company to promote its products more effectively and at the same time use the tendency of the consumers obtained in the public relations process in a statistical manner.

As described above, the ads currently provided on the Internet sites are merely displayed periodically at a predetermined time interval after being arranged at random. Therefore, users are not very interested in the ads, so the number of views is small and there are many difficulties in inducing the purchase of products and services through the ads.

### SUMMARY OF THE INVENTION

To solve the problems specified in the background art above, the present invention aims to provide a platform system for product marketing services, which provides advertisers with the opportunity to market products at a minimal cost and maximize the advertising effect by actively inducing interest from potential customers, provides consumers with the opportunity to acquire the desired products without additional purchase cost, and naturally promotes the products by causing delightful tension and interest to consumers in the course of the game for acquiring goods to stimulate the possessiveness.

Meanwhile, the object of the present invention is not limited to the above-mentioned objects, and other objects not mentioned can be clearly understood from the following description.

The above-mentioned object, according to an embodiment of the present invention, can be achieved by a platform system for product marketing services to be implemented through a server connectable to user terminals including a personal computer, a mobile device, and kiosk, which is characterized in that it includes: a mileage providing unit that pays mileage for certain online activities conducted under an ID of a member who accessed and logged in to a web page hosted on the server through the user terminals; a marketing game preparing unit that receives an image file containing specifications and promotional information of a product to be marketed from a vendor's terminal and exposes the image file in a frame form on a web site as a game waiting product; a marketing game generating unit that is linked to the frame of the aforesaid marketing game preparing unit, generates a game program to which a timer module and a stopwatch module are applied, and starts the game program at a predetermined time; and a marketing game control unit that subtracts a predetermined mileage from at least one member ID connected to the game program and selects a prize winner with the member ID that closes closest to a specified second by using the stopwatch module at a time set by the timer module.

Preferably, the aforesaid marketing game control unit further includes a 1st count control module for controlling a start of the count by driving the aforesaid timer module according to a predetermined condition when the member ID is connected to the game program.

Preferably, the aforesaid marketing game control unit further includes a 2nd count control module for initializing the timer module being driven and restarting a count when an event satisfying a certain condition occurs after the start of counting.

Preferably, the 2nd count control module further imposes an additional condition on the other member ID when an event occurs in which the other member ID is connected to the game program after the start of counting and initializes the timer module only when the additional condition is satisfied.

Preferably, the aforesaid additional conditions include at least one of mileage bid amount, game penalty, purchase history, advertisement viewing, and personal information being provided.

Preferably, the aforesaid marketing game control unit may further include a sensory time adjustment module for controlling the seconds counted by the aforesaid timer module to be different from an actual seconds unit.

Preferably, the timer module is individually applied to each of the member IDs connected to the game program, and at least one timer module is controlled by the sensory time adjustment module.

Preferably, the sensory time adjustment module varies the seconds of the timer module differently from the actual seconds unit based on a certain condition included in a personal information of the member ID connected to the game program and applies different sensory time for each member ID.

Preferably, the certain condition of the aforesaid personal information includes at least one of age, gender, birthday, online activity history, and history of participation in the game program, which are registered in each member ID.

Preferably, a big data collecting unit is further included to collect and store at least one of personal information, online activity history, history of participation in the game program, product acquisition history, and review history.

As described above, the present invention is expected to give the following effects:

First, advertisers can market products with minimal cost, since they advertise only their own products for sales.

Second, it is possible to maximize advertising effect by inducing interest from potential consumers who want to obtain products free of charge.

Third, the consumer has the opportunity to get the desired product free of charge through the game without any additional purchase cost.

Fourth, it is possible to induce delightful tension and interest from consumers and stimulate the possession of products in the course of playing a game for acquiring products, thereby naturally promoting the products.

Fifth, everyone can get equal opportunity to obtain goods through a specialized game method, so the degree of concentration for obtaining the goods free of charge is improved and the customer loyalty and satisfaction can be enhanced.

Sixth, it is possible to improve the sales by a separate web site advertisement, since it is possible to increase the number of users on a web page for marketing service.

Seventh, personal information collected after consent from member IDs for accessing a web page for marketing service, purchase history, and history of past activities can be stored as big data and utilized for various purposes.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram schematically illustrating a platform system for product marketing services according to an exemplary embodiment of the present invention,

FIG. 2 is a block diagram illustrating an embodiment that may be added to the present invention, and

FIGS. 3 to 5 illustrate a web page in which a platform system for product marketing services according to an embodiment of the present invention is implemented.

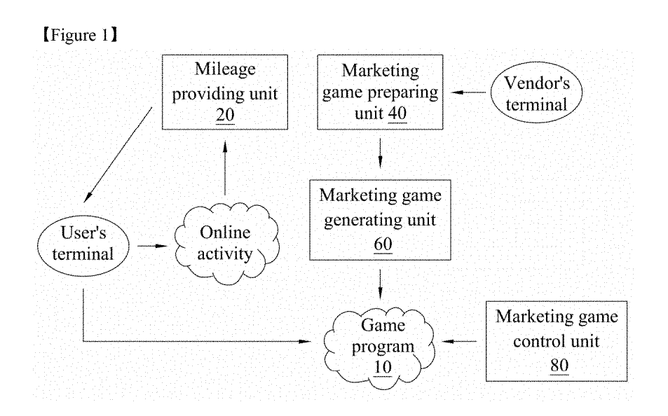

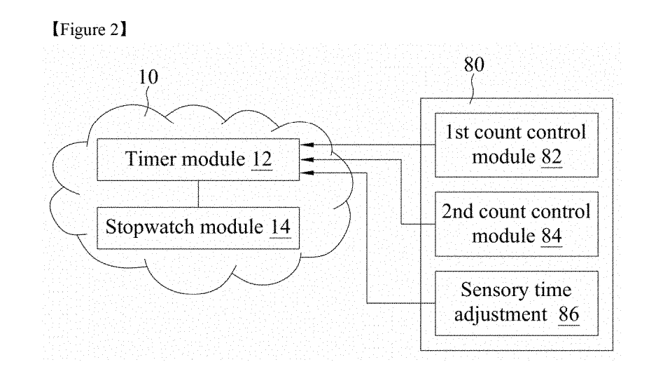

### DETAILED DESCRIPTION OF THE PREFERRED EMBODIMENTS

Exemplary embodiments of the present invention are described herein in the context of a platform system for product marketing services.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

The benefits and characteristics of the present invention and the methods of implementation will be clarified with reference to the embodiments to be described below in detail along with attached drawings. The present invention, however, is not limited to the embodiments set forth herein but will be embodied in many different forms. Rather, these embodiments are provided to complete the disclosure of the present invention and to fully convey the concept of the present invention to those of ordinary skill in the art related to the present invention. And the terms used herein serve to explain the embodiments and are not intended to limit the present invention. In this specification the singular includes the plural unless otherwise specified.

With reference to the accompanying drawings, the present invention will be described in more detail below. On the other hand, illustration and description of the configuration that can be easily understood by those of ordinary skill in the art as well as of operation and effects thereof will be omitted or briefed, while the parts related to the present invention will be described in detail.

The platform system for product marketing services according to an embodiment of the present invention can be implemented through a server connectable to user terminals such as normal PC, a mobile device, and kiosk. That is, the present invention is implemented in the form of a web page or an application serviced through the server.

The present invention, which can be implemented as described above, includes a mileage providing unit 20, a marketing game preparing unit 40, a marketing game generating unit 60, and a marketing game control unit 80.

First, the mileage providing unit 20 pays mileage for online activities of a certain condition, conducted under the name of member ID that accesses a web page hosted on the server through the user terminal. The mileage is used as a means for participating in a game program 10 to be described later and acquiring goods free of charge.

For example, users are not only able to earn mileage by signing up as a member of the site or surfing the web site, but also able to earn mileage by possible online activities (writing, clicking ads, buying items, games, etc.).

Next, the marketing game preparing unit 40 receives an image file containing the specification of the product to be marketed and the advertisement information from the vendor's terminal and promotes the product as a game waiting product by exposing the image file in a frame form on the web site.

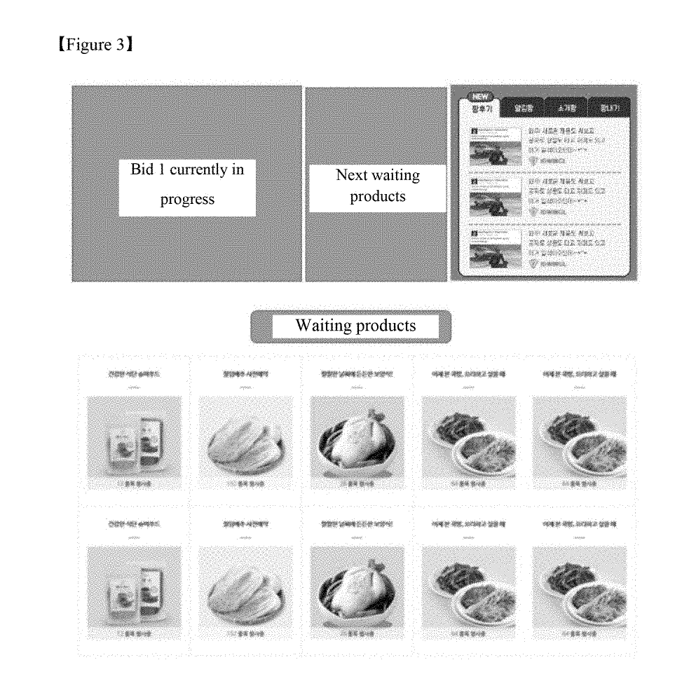

As illustrated in FIG. 3, a waiting product is exposed in advance, thereby inducing interest from users and enabling a natural advertising effect. At this time, it is possible to arrange a plurality of waiting products to induce interest from users having various preferences and provide detailed information about the product so that a user who is interested in the product can directly grasp the product information. Furthermore, it is possible to increase participation and interest at the game start time of the product by exposing the game start time for each product and adding the push notification setting.

Next, the marketing game generating unit 60 is linked to the frame of the marketing game preparing unit 40 and generates a game program 10 to which a timer module 12 and a stopwatch module 14 are applied, in order to start at the pre-determined time.

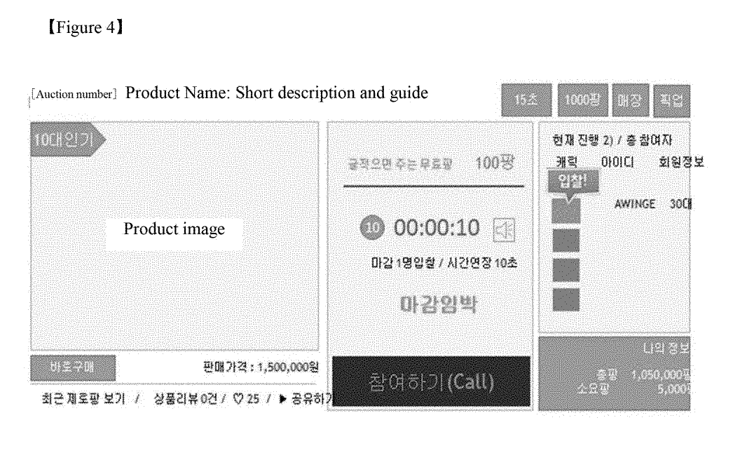

As illustrated in FIG. 4, when the user accesses the game program 10, a game with a timer module 12 and a stopwatch module 14 is exposed along with the product image and the member ID that is participating in the game and the bid information can be disclosed or closed according to the setting.

For example, if a user accesses the game program for desired product, he/she can participate in the game deduct the mileage or participate in the game in the way that the designated mileage is deducted or by bidding method.

Next, the marketing game control unit 80 subtracts a predetermined mileage from at least one member ID connected to the game program 10, and selects the member ID that closes closest to the specified second time as a prize winner by using the stopwatch module 14 at a time set by the timer module 12. For example, a 10-second count is set by the timer module 12, and a stopwatch is used to select a member ID that stops at the closest time to zero seconds (except for 0 seconds) as a prize winner.

In this case, the marketing game control unit 80 may further include a 1st count control module 82 that controls the start of counting by driving the timer module 12 according to a predetermined condition when a member ID is connected to the game program 10. That is, the aforesaid 1st count control module 82 drives the timer module 12 when at least one member ID is connected. At this time, the 1st count control module 82 drives the timer module 12 after a predetermined time after the first member ID's login. In other words, the 1st count control module 82 controls the start of counting by driving the timer module 12 according to the designated conditions such as operating the timer module 12 only when a predetermined number of member IDs are connected or at a designated time.

In addition, the marketing game control unit 80 may further include a 2nd count control module 84 for initializing the timer module 12 being driven to restart the counting when an event satisfying a certain condition occurs after the start of counting. That is, if an event satisfying a certain condition occurs even after the timer module 12 is driven by the 1st count control module 82 and the counting is started, the 2nd count control module 84 can reset the timer module 12.

At this time, the 2nd count control module 84, when an event occurs in which the other member ID is connected to the game program, imposes an additional condition on the other member ID and initializes the timer module 12. For example, if the game count starts when a user enters within a specified time after paying 100 points of mileage, other members who enter after that have to pay more than 100 mileage, for example 200 mileage, to join the game program 10. Then the counting of the timer module 12 is restarted and the game is restarted from the beginning.

On the other hand, the additional condition for the 2nd count control module 84 to initialize the timer module 12 may include at least one of game penalty, purchase history, advertisement viewing, and personal information being provided as well as mileage bid amount.

Further, the marketing game control unit 80 may further include a sensory time adjustment module 86 for controlling the seconds counted by the timer module 12 to be different from actual seconds unit.

At this time, it is preferable that a timer module 12 is individually applied to each of the member IDs connected to the game program 10 and that at least one timer module 12 is controlled by the sensory time adjustment module 86. That is, the timer module 12 that is counted at different sensory time for each member ID is individually applied, so that an advantage or a penalty for a different reaction speed can be given to each user.

The aforesaid sensory time adjustment module 86 varies the seconds of the timer module 12 to be different from the actual seconds units based on certain conditions included in the personal information of the member IDs connected to the game program 10. It is desirable to apply different sensory time for each member ID.

In this case, the condition of the personal information includes at least one of age, gender, birthday, online activity history, and participation history in the game program, which are registered in each member ID. For example, since the response speed to the stopwatch is different for each age group, such as 20s, 30s, and 40s, the second counts seems to be the same, but the second unit for each age group is actually applied incorrectly. In other words, while one second is actually 1000 milliseconds, one second normally counts as 1000 milliseconds for the 20 s, but it counts as 100 milliseconds for the 40 s. Thus, by giving an advantage in consideration of the equality of people with a high age, users of various age groups can acquire fairly.

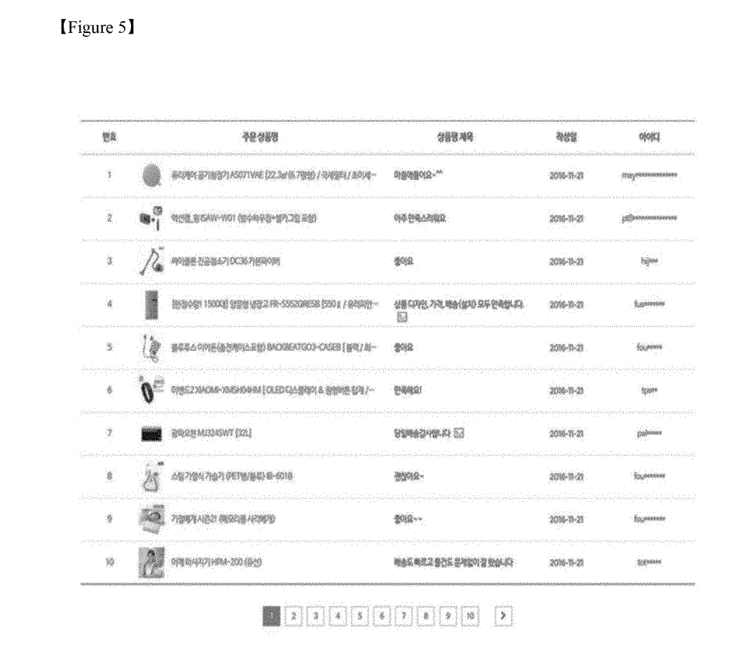

Further, in order to prevent the concentration of product acquisitions on a small number of users skilled in game, participation of the game program may be restricted for a predetermined period after acquisition of a product. As shown in FIG. 5, the participation of the other game programs is restricted until the user writes a review of the acquired product. In addition, it is possible for the manager to encourage sincere reviews by giving a penalty to a review without any sincerity, and to maintain loyal customers in the long term by giving credibility to the prospective purchasers for the reviews of the product.

In addition, according to another embodiment, the present invention may further include a big data collecting unit that collects and stores at least one of personal information, online activity history, game program participation history, and product acquisition history, which are registered in the member ID. This big data collecting unit helps to easily grasp the change of customer purchase habits according to the age and sex, and can be used for various purposes including product marketing.

According to the embodiments of the present invention described so far, the following effects can be expected:

First, since advertisers can advertise products only for sale, they can market their products with minimal cost.

Second, it is possible to maximize the advertisement effect by inducing interest from potential consumers to obtain the product free of charge.

Third, consumers have the opportunity to obtain products free of charge through games without any additional purchase cost.

Fourth, it is possible to induce pleasant tensions and interest from consumers in the course of playing a game for acquiring goods and stimulate the desire to possess the corresponding product, naturally promoting the product.

Fifth, regardless of age and gender, everyone can get an equal opportunity to acquire goods through a specialized game method. Therefore, it is possible to improve the degree of concentration for obtaining the goods free of charge and enhance the customer loyalty and satisfaction.

Sixth, since it is possible to increase the number of users on a web page for marketing service, the sales by a separate web site advertisement can be improved.

Seventh, it is possible to save as big data the personal information and the purchase and review history collected after the consent from the member ID accessing the web page for marketing service, and to utilize them for various purposes.

The features and technical advantages of the present invention have been described above for a better understanding of claims of the invention which will be described later. It will be understood that the technical configuration of the invention described above may be embodied in specific forms by those skilled in the art of the present invention without changing the technical idea or essential features of the present invention. Therefore, it should be understood that the embodiments described above are intended to be illustrative in all respects to be understood as non-limiting, that the scope of the present invention appears in the claims below rather than by the description above, and that the spirit and scope of the claims and all the changes or modified forms deriving from its equivalents fall within the scope of the present invention.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A platform system for product marketing services that is implemented through a server connectable to user terminals including a personal computer, a mobile device, and kiosk, the platform system for product marketing services comprising:
a mileage providing unit that pays mileage for certain online activities conducted under an ID of a member who accessed and logged in to a web page hosted on the server through the user terminals;
a marketing game preparing unit that receives an image file containing specifications and promotional information of a product to be marketed from a vendor's terminal and exposes the image file in a frame form on a web site as a game waiting product;
a marketing game generating unit that is linked to the frame of the aforesaid marketing game preparing unit, generates a game program to which a timer module and a stopwatch module are applied, and starts the game program at a predetermined time; and
a marketing game control unit that subtracts a predetermined mileage from at least one member ID connected to the aforesaid game program and selects a prize winner with the member ID that closes closest to a specified second by using the stopwatch module at a time set by the timer module,
wherein the aforesaid marketing game control unit comprising a sensory time adjustment module for controlling seconds counted by the aforesaid timer module to be different from an actual seconds unit.

2. The platform system for product marketing services according to claim 1, wherein the aforesaid marketing game control unit comprises a 1st count control module that controls a start of counting by driving the timer module according to a predetermined condition when the member ID is connected to the game program.

3. The platform system for product marketing services according to claim 2, wherein the aforesaid marketing game control unit comprises a 2nd count control module that initializes the timer module being driven and restarts a count when an event that satisfies a certain condition occurs after the start of counting.

4. The platform system for product marketing services according to claim 3, wherein the aforesaid 2nd count control module imposes an additional condition on the other member ID when an event occurs in which the other member ID is connected to the game program after the start of counting and initializes the timer module only when the additional condition is satisfied.

5. The platform system for product marketing services according to claim 4, wherein the aforesaid additional condition comprises at least one of mileage bid amount, game penalty, purchase history, advertisement viewing, and personal information being provided.

6. The platform system for product marketing services according to claim 1, wherein the timer module is individually applied to each of the member IDs connected to the aforesaid game program and at least one timer module is controlled by the aforesaid sensory time adjustment module.

7. The platform system for product marketing services according to claim 6, wherein the aforesaid sensory time adjustment module varies the seconds of the timer module differently from the actual seconds unit based on a certain condition included in a personal information of the member ID connected to the game program and applies different sensory time for each member ID.

8. The platform system for product marketing services according to claim 7, wherein the aforesaid certain condition of the personal information comprises at least one of age, gender, birthday, online activity history, and game program participation history registered in each member ID.

9. The platform system for product marketing services according to claim 1, further comprising a big data collecting unit for collecting and storing at least one of personal information registered in the member ID, online activity history, game program participation history, and product acquisition history.
